(19) United States
(12) Patent Application Publication
(10) Pub. No.: US 2021/0113978 A1
(43) Pub. Date: Apr. 22, 2021

(54) MIXING VESSEL

(71) Applicant: August Berger Metallwarenfabrik GmbH, Berg (DE)

(72) Inventor: Detlev WEYRAUCH, Kreuzau (DE)

(21) Appl. No.: 17/072,853

(22) Filed: Oct. 16, 2020

(30) Foreign Application Priority Data
Oct. 19, 2019 (DE) 202019004338.1

(51) Int. Cl. B01F 15/00

(52) U.S. Cl. CPC B01F 15/00837; B01F 15/00668

(57) ABSTRACT

The present invention relates to a mixing vessel (10) for mixing liquid or fluid filling goods, with a cylindrical vessel wall (12) and a disc-shaped lower vessel bottom (14).

For producing said mixing vessel (10) in an inexpensive way and for enabling its quick preparation for reuse, it is provided according to the invention that the mixing vessel (10) comprises at least four individual, detachably connected vessel components, namely a cylindrical vessel wall (12), a disc-shaped lower vessel bottom (14), a liner bag (16) made of thin-walled synthetic foil which is inserted into said vessel wall, and a clamping ring (18) which connects the disc-shaped lower vessel bottom (14) with the vessel wall (12), whereby said inserted liner bag (16) comprises a cylindrical liner wall (20) and a disc-shaped liner bottom (22), and whereby said liner bag (16) is firmly affixed in the lower area of the cylindrical vessel wall (12) or/and of the disc-shaped lower vessel bottom (14).

The present invention relates to a mixing vessel for mixing liquids, with a cylindrical vessel wall, a disc-shaped lower vessel bottom and a liner bag inserted into it.

Mixing vessels are needed in different industries, as for example in the chemical, lacquer, plastics or food industry, for producing liquid intermediate and end products. Mixing vessels are also known as pharmaceutical containers for mixing and blending of e.g. ointments, as reactors and storage containers for the production of adhesives and paints or as agitator vessels for the food industry for homogenizing and mixing of sauces, marinades or other liquid media. The stirring and mixing of the liquids is basically effected by an inserted agitator or mixing tool. The mixing tool such as a propeller stirrer is selected depending on the viscosity of the liquids to be mixed.

Previously known mixing vessels usually consist of stainless steel components that are screwed or braced together and are very expensive. They have to be cleaned in a time-consuming procedure for each reuse plus the washing liquid has to be prepared and disposed of in a complex way. In order to simplify the cleaning of the mixing vessels, some industries have started to equip the mixing vessel with a liner bag which, as a disposable protective lining, protects the interior of the mixing vessel from the adhesion of mixed material.

A mixing vessel with a liner bag inserted into it is known from publication EP 2 168 670 B1, for example. It describes a bulk material mixing machine for mixing powdery bulk material or granules (e.g. powder mixtures for paint production or plastic granulate mixtures), which has a base plate with a cylindrical outer container attached to it and a lifting column arranged next to it. On the lifting column, a heavy container lid with a mixing tool attached can be moved vertically and swiveled horizontally to the side. An inner container is inserted into the outer container, which is referred to as the container holder. A liner bag—also known as a container or plastic bag—is then inserted into the inner container, into which the powdery mixing material to be mixed is filled. The upper end of the liner bag is then folded over the opening edge of the inner container and is later clamped by the placed lid against the opening edge of the inner container. For better accessibility, the container lid is raised and swiveled to the side for filling the liner bag—as well as for removing it. The inner container is provided with a large number of openings in the manner of a grid in the area enclosed by the outer container, and the outer container is equipped with a connection for a vacuum pump. During mixing operation, a vacuum is generated inside the outer container, so that the liner bag is sucked against the inner wall of the inner container and thus fixed.

After the mixing process is completed, the lid attached to the lifting column, together with the mixing tools, is moved upwards out of the mixing container and swung to the side, after which the liner bag—after the vacuum pump has been switched off—can be removed upwards from the inner container as a container with the readily mixed material. The liner bag can still be closed before it is removed from the inner container. To facilitate insertion and removal, the liner bag is conically tapered from its upper filling opening down to the bottom.

DE 20 2013 103 591 U1 describes an industrial mixing machine, which has an upper mixing head carrying one or more mixing tools and a lower mixing container, both of which are connected via a peripheral ring flange. The lower mixing container has an annular cylindrical container body, to which a truncated cone or conical container part with a bottom outlet channel and a lockable outlet fitting is connected at the bottom. The lower mixing container is fitted with an appropriate cylindrical/conical form liner, which has a circumferential flange edge at its upper edge, which is positioned and clamped between the circumferential ring flanges of the upper mixing head and the lower mixing container. At the bottom, the form liner opens into the outlet channel of the mixing container with a tubular outlet extension and is clamped there by a disc-shaped closing flap of the outlet fitting. To carry out the mixing process, the mixing material is filled into the lower mixing container, after which the mixing container is connected and locked to the upper mixing head. The mixing head and mixing container are then turned into an overhead position so that the mixing material can be mixed by the mixing tools arranged in the mixing head. A certain overpressure is built up in the mixing chamber so that the form liner remains in its contact position against the inner wall of the mixing container during the mixing process, so that the mixing process is not disturbed. In this well-known mixing machine, the lower mixing container is protected from contamination or caking by the form liner used, however the upper mixing head with the mixing tools arranged in it must be elaborately cleaned after each mixing process. Due to the elaborate construction with swivel device and the specially shaped form liner, this cost-intensive mixing device with the still necessary washing process is not very environmentally friendly and uneconomical.

Furthermore, U.S. Pat. No. 5,465,863 describes a special container in particular for the storage and transport of hot melts. The container, preferably a steel drum container, consists of a cylindrical container wall, a bottom and a lid or top, which are attached to the cylindrical container wall with two clamping rings. The steel drum is provided with a removable liner made of fiber foil material (rolled fiber foil, kraft paper). The liner consists of three separate parts, i.e. two discs which are adhesively positioned at the inside surface of the top and bottom and a rectangular foil which is, with an overlap, adhesively positioned around the inner surface of the cylindrical container wall. For this purpose, the entire inner surface of the steel drum is coated with an adhesive.

Hot melt adhesives are filled hot in a viscous state and solidify at room temperature. To remove the solidified hot melt adhesive from the opened lidded drum, a heated plunger is used, which pumps out the hot melt adhesive melting on top through the central plunger. However, the well-known steel drum with the removable three-part liner is not suitable for holding liquids because it has no seal at the lower clamping ring connection between the cylindrical container wall and the bottom. A clamping ring closure can never be sealed solely with the overlapping incompressible fiber foil coatings of the cylindrical container wall and disc-shaped bottom. As soon as the disc-shaped liner made of kraft paper is inserted and pressed into the upwardly open U-shaped circumferential groove in the bottom cover, said grove being intended to accommodate the rolled edge of the cylindrical container wall, inevitably small wrinkles are caused which always result in a leakage of the container. In case of a hot melt filling material, these mini wrinkles are not critical, since the small amount of hot melt filling material that penetrates the leakages immediately cools and solidifies and thus sufficiently seals the container. This drum cannot be used for common low-viscosity filling materials such as paints and lacquers.

### Objective of the Invention

It is the objective of the present invention to propose a mixing container with liner bag, which is very inexpensive to manufacture on the one hand and which can be quickly and easily reconditioned and made ready for use on the other hand.

### Solution

This objective is solved in the present invention by the fact that the new mixing vessel, following a structurally simple design, comprises at least four individual, detachably connected vessel components, namely a cylindrical vessel wall with an upper and a lower rolled edge, a disc-shaped lower vessel bottom, a liner bag made of thin-walled plastic and/or metal foil inserted into the vessel wall and a lower clamping ring connecting the disc-shaped lower vessel bottom with the container wall, wherein the inserted liner bag has a cylindrical liner wall and a disc-shaped liner bottom, and wherein the disc-shaped liner bottom is provided with a flange edge which projects beyond the cylindrical liner wall and which, in the inserted state, is arranged circumferentially between the disc-shaped lower vessel bottom and the lower edge of the vessel wall and is clamped firmly and non-rotatably by the mounted lower clamping ring.

By combining simple components, which are available in the usual steel drum production, such as the cylindrical vessel wall open at both ends, the disc-shaped vessel bottom, the clamping ring closure and the cylindrical liner bag, it is possible to produce in a surprisingly simple way a very inexpensive mixing vessel—compared to known construction variants made of stainless steel.

Cylindrical vessel walls which are open at both ends are a semi-finished or intermediate product in the manufacture of lidded drums made of sheet steel. These are also called “frame” before the disc-shaped drum bottom is firmly fastened and undetachably rolled or seamed.

As an important constructional measure, fixing the liner bag in the inserted state circumferentially between the disc-shaped lower vessel bottom and the lower edge of the vessel wall by mounting the lower clamping ring is a simple and safe way to prevent the liner bag from twisting and creasing during the mixing process due to friction of the mixed material. The suitability as a mixing vessel is only guaranteed by assembling the cylindrical vessel wall and the disc-shaped vessel bottom detachably by means of the clamping ring closure and by the simple possibility of fixing the liner bag in its lower area in an easily detachable manner.

For a secure fixing of the liner bag, the disc-shaped liner bottom is provided with a flange edge which protrudes over the cylindrical liner wall, said flange edge in the inserted state is arranged circumferentially between the lower disc-shaped vessel bottom and the lower edge of the vessel wall and is clamped firmly and non-rotatably by the mounted lower clamping ring. In order to achieve a sufficient clamping effect, the disc-shaped liner bottom has a flange edge protruding beyond the diameter of the cylindrical liner wall and said flange edge having a width of at least 10 mm. Such a liner bag with a disc-shaped liner bottom and an externally protruding flange edge can be produced easily and inexpensively.

And with such a liner bag with a flange edge protruding radially from the lower edge of the cylindrical liner wall, it is particularly easy to insert and fix the liner bag in the mixing vessel and to replace and remove the used liner bag. To do this, basically only the lower clamping ring needs to be mounted and tightened or loosened.

The embodiment of the invention provides that the outer circumferential edge of the flange edge of the liner bottom which is welded onto the cylindrical liner wall alternately has a larger and a smaller distance A, a to the cylindrical liner wall. The smaller distance a from the cylindrical liner wall to the outer circumferential edge shall be at least 20 mm and the larger distance A from the cylindrical liner wall to its outer circumferential edge shall be at most 200 mm.

In a preferred constructive embodiment, the liner bottom welded onto the cylindrical liner wall has a square basic shape.

When placing the bottom lid on the edge of the vessel, unavoidable mini wrinkles occur in the flange edge of the liner bottom in the U-shaped circumferential groove in the lid edge. In the present invention, these mini wrinkles are only of advantage for an improved holding/fixing function of the protruding flange edge, because a sealing function for the liner bag is not required here, but only a fixing function.

Furthermore, for the construction of a closed mixing vessel, it is intended that an upper disc-shaped vessel lid with an appropriate bunghole and a second upper clamping ring connecting the upper vessel lid with the upper edge of the vessel wall is placed on the four individual, detachably connected vessel components.

The advantages of the mixing vessel according to the invention are:

The productivity of the cleaning process is significantly increased; the need for washing liquid and its subsequent recycling is greatly reduced. The cleaning process is easy on the equipment and the cleaning personnel, the cleaning residues are easier to dispose of.

The mixing vessel according to the invention is made of sheet steel from individual standardized components from the steel drum production, e.g. for 215 liter or 300 liter lidded drums. This guarantees an extremely inexpensive production of the mixing vessels.

In a different embodiment, the mixing vessel according to the invention can be produced with a cylindrical vessel wall made of plastic or layered kraft paper(=fiber drum). Also, the disc-shaped upper vessel lid and the disc-shaped lower vessel bottom can be made of plastic or plywood. These components are available from the usual production of plastic lidded drums and fiber drums.

The liner bag is very simply made from a tubular foil with welded-on bottom disc and consists of thin-walled plastic or metal foil or a multi-layer mix of these.

All measures specified in the claims or in the description are—as far as technically possible—interchangeable and/or combinable with each other.

With the present invention, mixing vessels can be manufactured in an extremely cost-efficient way and can be reused many times in a sustainable and environmentally friendly way. In the following description of the figures, further inventive features are specified.

In the following, the invention is explained and described in more detail by means of examples as shown in the drawings, wherein:

### BRIEF DESCRIPTION OF THE DRAWINGS

FIG. 1 shows a mixing vessel according to the invention in a schematic view;

FIG. 2 shows a cylindrical vessel wall for a mixing vessel in the shape of a 215 liter steel drum;

FIG. 3 a cylindrical vessel wall for a mixing vessel in the shape of a 300 liter steel drum;

FIG. 4 shows a schematic structure of a mixing vessel according to the invention with folded liner bag;

FIG. 5 shows a schematic structure of the mixing vessel as shown in FIG. 4 with a partially raised liner bag and closed bottom lid;

FIG. 6 shows a schematic structure of the mixing vessel as shown in FIG. 4 with the liner bag completely raised and the indicated vessel lid with upper clamping ring;

FIG. 7 shows the individual components of the mixing vessel with a roller block on wheels underneath in an exploded view;

FIG. 8 shows a schematic structure of the mixing vessel according to the invention with an agitator/mixing tool installed;

FIG. 9 shows a liner bag made of thin-walled plastic foil with a protruding flange edge at the bottom of the liner bag in a schematic view;

FIG. 10 shows a mixing vessel with an outlet valve at the bottom;

FIG. 11 shows an example of a filling and discharging pumping pipe for insertion into the upper lid of the mixing vessel;

FIG. 12 shows a particularly preferred embodiment of a liner bag with a square-shaped liner bottom flanged edge in top view;

FIG. 13 shows a mixing vessel according to the invention with inserted liner bag according to FIG. 12 in side view and

FIG. 14 shows a lower corner area of the mixing vessel as shown in FIG. 13 in enlarged view.

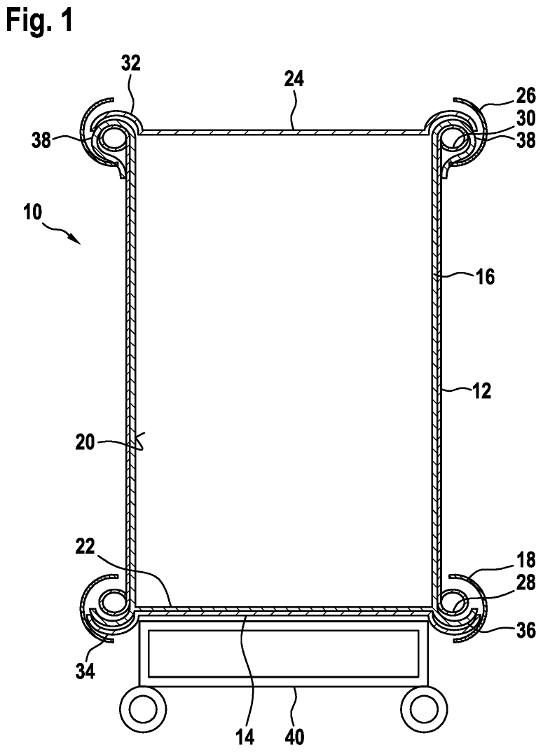

In FIG. 1, reference number 10 designates a mixing vessel according to the invention for mixing liquid or fluid filling materials, which in a closed version comprises six essential components, namely a cylindrical vessel wall 12, a disc-shaped lower vessel bottom 14, an inserted liner bag 16 made of thin-walled plastic foil, a lower clamping ring 18 connecting the disc-shaped lower vessel bottom 14 with the vessel wall 12, a disc-shaped upper vessel lid 24 and an upper clamping ring 26. An open version of the mixing vessel 10 does not require an upper vessel lid 24. In any case, the cylindrical vessel wall 12 is provided with a lower rolled edge 28 and an upper rolled edge 30. The rolled edges 28, 30 are formed as lay-on edges for the lower vessel bottom 14 and the upper vessel lid 24, said rolled edges 28, 30 providing stable counter bearings for clamping the upper and lower clamping rings 26, 18 and thus serving to close the upper and lower vessel opening of the cylindrical vessel wall 12.

The disc-shaped lower vessel bottom 14 is identical to the disc-shaped upper vessel lid 24 and bungholes contained therein are closed with a bung. The vessel lid 24 as well as the vessel bottom 14 are provided with semicircular outer edges 32, 34 adapted to the respective rolled edges 28, 30 of the vessel wall 12, into which a standard PU seal can be glued or foamed. In the closed state, the semicircular outer edges 32, 34 of the vessel lid 24 and vessel bottom 14 are clamped by the respective clamping ring 26, 18 and the seals arranged therein are pressed onto the rolled edges 28, 30.

The liner bag 16 comprises a cylindrical liner wall 20 and a disc-shaped liner bottom 22 and at the lower edge it is provided with a flange edge 36 radially protruding from the liner bottom 22 and, if applicable, with a radially protruding flange edge 38 at the upper edge.

According to the present invention, in the inserted state, the lower outwardly protruding flange edge 36 of the liner bag 16 is arranged circumferentially between the semicircular outer edge 32 with sealing ring of the lower disc-shaped vessel bottom 14 and the lower rolled edge 28 of the container wall 12 and is clamped firmly and non-rotatably by the mounted lower clamping ring 18. The flange edges 36, 38 at the upper and lower edge of the liner wall 20 have a width of at least 10 mm in order to achieve a sufficient clamping effect and fixation of the liner bag inside the mixing vessel.

The upper vessel lid 24 with clamped upper clamping ring 26 fixes the upper radially protruding flange edge 38 of the liner bag 16 in the same way. The sealings in the vessel lid 24 and in the vessel bottom 14 of the mixing vessel 10 are advantageous for clamping the liner flange edges 36, 38 as they ensure a gentle but nevertheless firm clamping of the thin-walled liner flange foil.

For the insertion of an agitator or mixing tool 52 and/or a filling/discharging pumping pipe 56, the upper vessel lid 24 is provided with a 3-inch bunghole, a 2-inch bunghole and/or a ¾ inch bunghole as inspection opening. In a favorable embodiment, the mixing vessel 10 is placed on a roller block 40 and can thus be moved back and forth easily.

In an open version without upper vessel lid 24, a crossbar can be placed on the upper rolled edge 30 as a holder for a mixing tool and fixed with the upper clamping ring 26. In a simple version without upper flange edge 38, the cylindrical liner wall 20 can be extended upwards. To fix the liner bag 16 at the top, the extended liner wall 20 is folded outward over the upper rolled edge 30 of the vessel wall 12 and fixed with the clamping ring 26; if applicable, it can also be secured with a thin clamping belt or with adhesive tape.

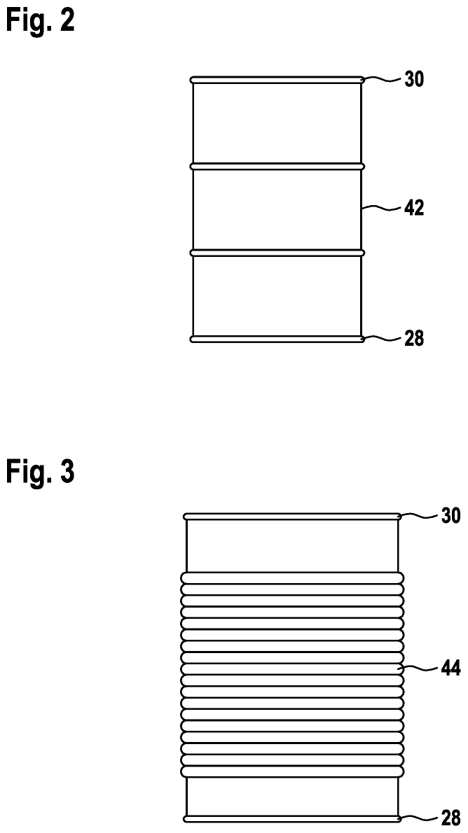

Cylindrical vessel walls that are open at both ends—often referred to as “frame”—are generated as semi-finished or intermediate products in the production of conventional lidded drums made of sheet steel with preformed rolled edges. As an example, FIG. 2 shows a cylindrical vessel wall 42 for a mixing vessel 10 according to the invention in the form of a 215 liter steel drum and FIG. 3 shows a cylindrical vessel wall 44 for a mixing vessel 10 in the form of a 300 liter steel drum, each with a lower and upper rolled edge 28, 30.

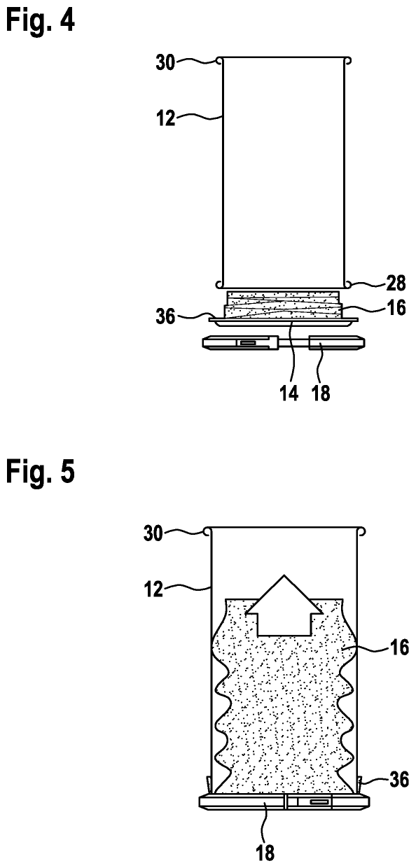

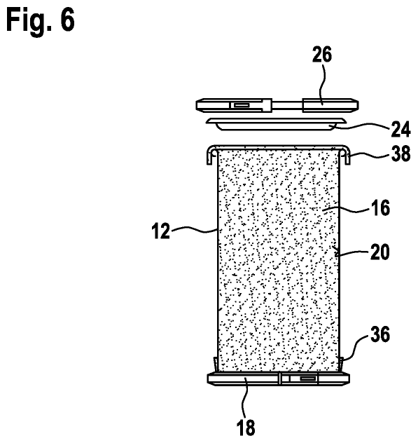

In FIGS. 4 to 6, the simple insertion process for the liner bag 16 is shown schematically. In FIG. 4, the flat folded liner bag 16 is placed on the lower vessel bottom 14 in such a way that the lower flange edge 36 of the liner bag 16 covers the semicircular outer edge 34 of the disc-shaped vessel bottom 14 which is open at the top. Then the cylindrical vessel wall 12 is placed with the lower rolled edge 28 on the flange edge 36 and the lower clamping ring 18 is clamped, whereby the circumferential flange edge 36 of the liner bag 16 is clamped and fixed between the semicircular outer edge 34 of the vessel bottom 14 and the lower rolled edge 28 of the vessel wall 12. Then the liner bag 16 is pulled up—as can be seen in FIG. 5. When the liner bag 16 is fully pulled up, as shown in FIG. 6, the upper flange edge 38 is placed over the upper rolled edge 30 of the vessel wall 12, the vessel lid 24 is placed on top and the upper clamping ring 26 is clamped. This shows that the mixing vessel can be equipped with a liner bag 16 and made ready for use in just a few steps and in a very short time. It is just as easy and quick to replace a used liner bag with a new liner bag in order to make the mixing vessel ready for the next mixing process with other mixing material.

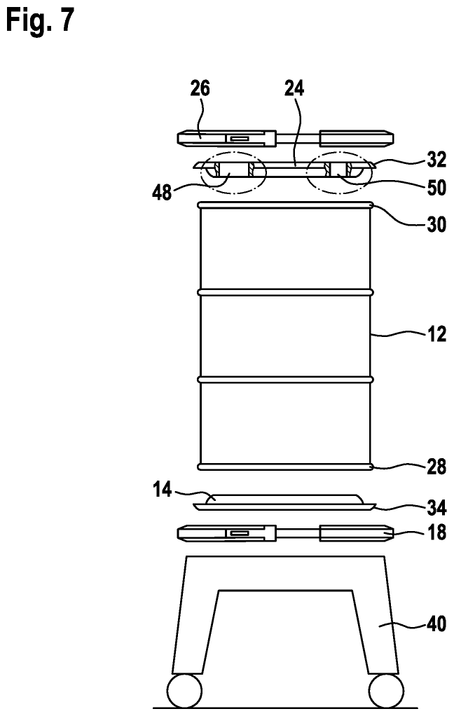

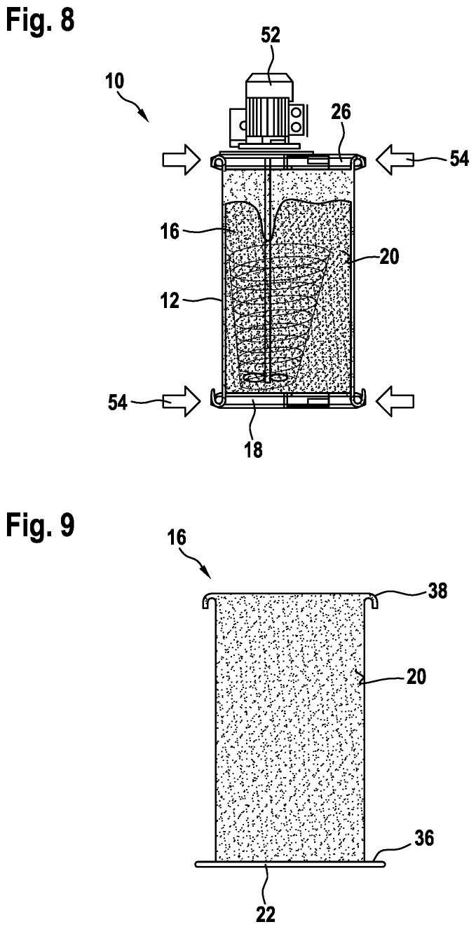

An exploded view of the individual components of the mixing vessel 10 according to the invention is shown in FIG. 7. The vessel wall 12 is provided with rolled edges 28, 30 at the bottom and top, to which the lower vessel bottom 14 and the upper vessel lid 24 are firmly connected by means of the lower and upper clamping rings 18, 26. The liner bag 16 located inside the vessel wall 12 is not shown here. The upper vessel lid 24 has a 3-inch bunghole 48 and a 2-inch bunghole 50, into which an agitator/mixing tool 52 and a filling/discharging pumping pipe 56 can be inserted. The schematic diagram in FIG. 8 shows that an agitator/mixing tool 52 is inserted into the vessel lid 24. Furthermore, the arrows 54 indicate that the liner bag is firmly fixed by the upper and lower circumferential clamping of the flange edges of the liner bag. When thin liquids are mixed, splashes can easily occur which adhere to the underside of the vessel lid 24. In order to protect the vessel lid 24, a separate disc-shaped liner foil is arranged on the underside of the vessel lid 24 (not shown in the drawing), which is attached in an easily removable manner e.g. by means of an adhesive or double-sided adhesive tape. The diameter of the liner disc is at least as large as the diameter of the upper vessel lid 24, whereby the outer edge of the disc-shaped liner foil is arranged between the outer edge 32 of the upper vessel lid 24 and the upper rolled edge 30 of the cylindrical vessel wall 12 and is clamped firmly and non-rotatably by means of the upper clamping ring 26. When not clamped, the liner disc can protrude up to 20 mm beyond the diameter of the upper vessel lid 24.

FIG. 9 shows an individual depiction of the liner bag 16 with a cylindrical liner wall 20, with a lower disc-shaped liner bottom 22 and an adjacent radially outwardly projecting lower flange edge 36 as well as the upper flange edge 38 at the upper edge of the liner wall 20. Depending on the application, the liner bag 16 can be made of various materials, e.g. HDPE, LDPE (also antistatic), PP (antistatic as standard), mono films (LDPE, also antistatic and conductive), HDPE, polyamide or of multilayer co-extrusion films (antistatic and conductive), aluminum composite films. The film thickness (foil thickness) can be between 100 μm, 150 μm and 250 μm depending on the application.

For a 215 liter steel drum, for example, the liner bag consists of LDPE film with the dimensions 610×1300×0.2 mm. The film thickness can also be up to 0.5 mm for large vessels.

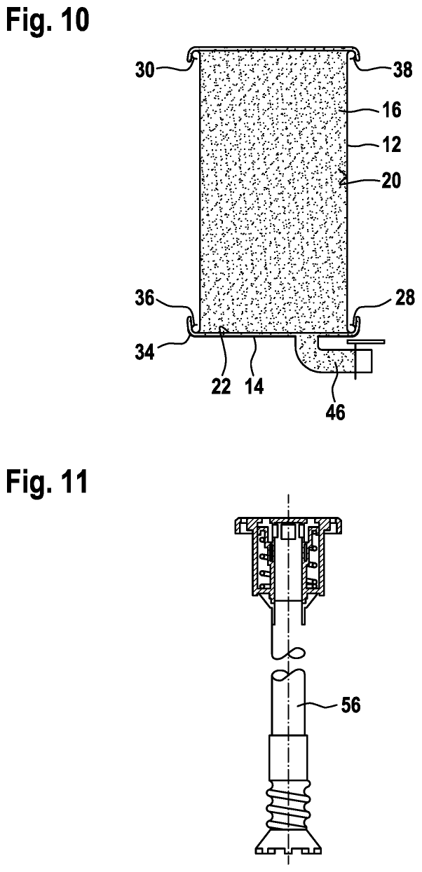

An open-top version of a mixing vessel 10 is shown in FIG. 10. In this case, the vessel bottom 14 is equipped with a discharge opening with an outer metal flange edge. This flange edge can be connected to a discharging pipe 46 with a lockable discharge valve for bottom-side discharging of the mixed material. When not in use, the discharge opening in the bottom can be closed by a blind plug so that a standard liner bag without bottom outlet can be used. In case the floor outlet is used, a corresponding thin-walled liner hose is welded onto the liner floor 22, which is inserted into the outlet pipe 46 and whose outer end is then clamped liquid-tight by another small clamping ring between the outlet pipe 46 and the discharge valve. It is advisable to place the mixing vessel 10 with the connected bottom outlet pipe 46 and discharge valve on a roller block (not shown).

In a preferred embodiment, the individual container components 12, 14, 18, 24, 26 are made of sheet steel and are all formed as standardized components as used in steel drum production. The standardized components for a steel drum mixing vessel can be taken from the steel drum production for a lidded steel drum with a volume of 215 liters or with a volume of 300 liters. In addition, mixing vessels of the type described can of course also be produced in other common volumes of 30, 60, 120, 150 or 250 liters.

In case mixing vessels are used in wet rooms, the cylindrical vessel wall 12 as well as the disc-shaped upper vessel lid 24 and the disc-shaped lower vessel bottom 14 can be made of plastic.

In another variation, the cylindrical vessel wall 12 of a mixing vessel according to the invention can be made of layered kraft paper as a fiber drum with preformed upper and lower rolled edges.

FIG. 11 shows the example of a well-known Micro Matic flat-fitting pipe for bung drums with 2″ bungholes, which is used for filling and discharging the liquid mixing good when the upper vessel lid 24 is clamped on.

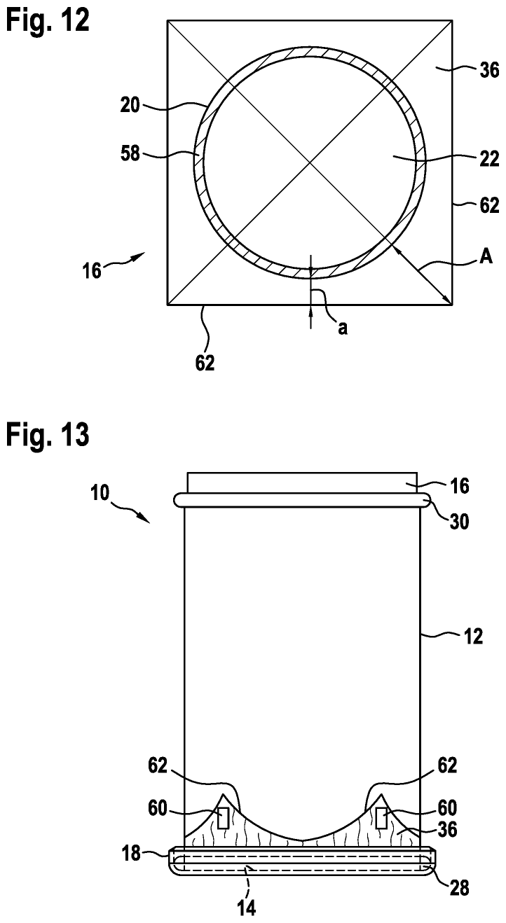

The preferred embodiment of the liner bag 16 is shown in FIG. 12. Here, the liner bottom 22 welded onto the cylindrical liner wall 20 with a flange edge 36 has a square shape. Known liner bags, so-called round bottom bags, are usually made by welding together a film tube with a given diameter and a cut-to-size bottom disc with the same diameter. For this purpose, the cylindrical film tube is folded inwards and firmly welded to the bottom disc. The unused excess film material of the bottom disc is cut off and discarded.

When manufacturing the liner bags 16 according to the invention with a square-shaped welded-on liner bottom 22 and flange edge 36, there is no waste material or only very little clipping, if an appropriate film width is used.

The diameter of the cylindrical liner wall for a liner bag for a standardized 215 ltr. steel drum is 570 mm, equal to the drum diameter. The square liner bottom then has an edge length of 610 mm with a protrusion of 2×20 mm. This results in a diagonal of 862 mm. Subtracting the diameter of 570 mm results in a protrusion of 146 mm in the corners.

As shown in FIG. 13 in schematic view, a liner bag 16 is inserted into the mixing vessel 10 as shown in FIG. 12. At the upper end of the mixing vessel 10, the liner bag 16 with its cylindrical liner wall protrudes beyond the upper rolled edge 30. At the lower end of the mixing vessel 10, two raised corners of the square flange edge 36 with attached fastening means 60 can be seen. In the present case, these fastening means 60 are flat magnetic strips, by means of which the raised corners of the square flange edge 36 are fixed in a yielding manner on the outside of the steel drum or vessel wall 12. For mixing vessels with non-magnetic vessel walls, such as plastic drums or fiber drums, elastic rubber bands can also be used as fastening means 60. In case stainless steel drums are used, also metallic retaining clips can be welded onto the lower container wall as fastening means.

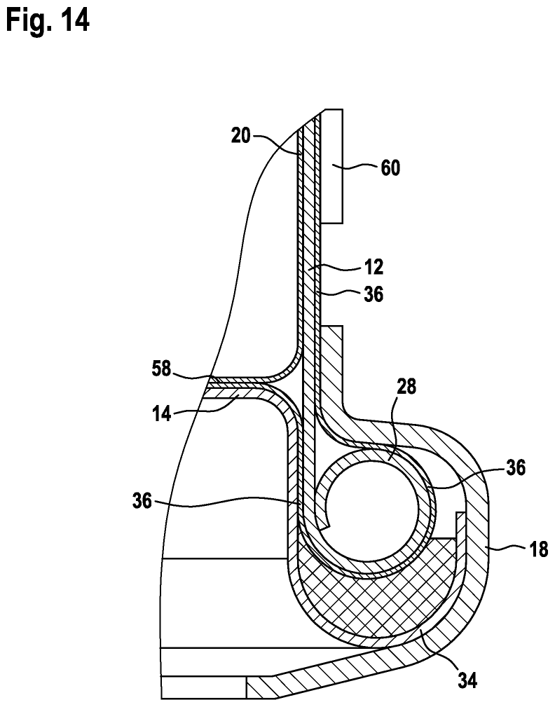

In FIG. 14, the enlarged view of a lower corner area of the mixing vessel 10 according to FIG. 13 additionally illustrates why a wide or square flange edge 36 is especially advantageous. The film thickness of the flange edge and respectively of the liner bag is shown in exaggerated thickness for better illustration.

When installing this liner bag, the corners of the liner bottom 22 are drawn over the bottom area 14 of the mixing vessel and fixed to the outside of the vessel wall 12 by magnets or fastening means 60. When the bottom lid 14 of the mixing vessel is now placed on the vessel, with the bottom lid moving into in the vessel body and the rolled edge 28 of the vessel wall 12 moving into the U-shaped circumferential groove 34 at the lid edge, the liner bottom 22 is stretched over the bottom lid 14 or drum bottom, whereby the free protrusion of the square flange edge 36 being shortened in the direction of the vessel body. At the same time, the corners in the fastening areas under the magnetic strips 60 slide towards the vessel bottom 14. The whole thing is then fastened by means of the mounted clamping ring 18. Afterwards, the mixing vessel is turned and the protruding liner wall of the liner bag is pulled over the upper edge of the vessel. For fixation, a clamping ring is also placed on the upper edge of the vessel and closed. Subsequently, a vacuum hose can be connected through a small closable opening in the upper vessel wall and the air between the vessel wall and the liner bag can be extracted. The liner bag is thus fixed tightly in the mixing vessel and the mixing vessel is ready for use. After using the mixing vessel, the liner bag is disassembled in reverse order.

If a closed mixing vessel is to be used, a vessel lid with appropriate bungholes and with the mixing tool inserted is placed on the vessel and fastened by means of the upper clamping ring. The underside of the vessel lid is provided with a corresponding disc-shaped lid liner with a protruding flange edge. For mounting purposes only, the disc-shaped lid liner can be attached to the underside of the vessel lid at certain points with a removable adhesive such as double-sided adhesive tape or adhesive pads. As soon as the vessel lid is placed on the vessel, the disc-shaped lid liner is pulled tightly over the vessel lid and is clamped by the upper clamping ring.

Conclusion:

The technical teaching of the present invention shows how in a surprisingly simple way a very inexpensive mixing vessel with liner bag can be provided for permanent use in repeatedly new mixing processes, whereby said mixing vessel, due to the detachable connection of its individual components, can be quickly and inexpensively converted for the next application and made ready for use in an environmentally friendly manner.

The proposed embodiment of the mixing vessel according to the invention with the liner bag fixed to the bottom circumference can certainly also be used as a simple lidded vessel for the storage and transport of moist or liquid filling goods. The filling material can then be safely sucked out of the vessel without the liner bag getting into the suction opening and clogging it. The filling material can also be simply poured out, whereby the liner bag remains in the vessel and does not fall into the poured out filling material.

### REFERENCE NUMBERS

| | |
|---|---|
| 10 | mixing vessel |
| 12 | cylindrical vessel wall (10) |
| 14 | disc-shaped vessel bottom (10) |
| 16 | thin-walled liner bag |
| 18 | lower clamping ring (10) |
| 20 | cylindrical liner wall (16) |
| 22 | disc-shaped liner bottom (16) |
| 24 | upper vessel lid (10) |
| 26 | upper clamping ring (10) |
| 28 | lower rolled edge (12) |
| 30 | upper rolled edge (12) |
| 32 | semicircular outer edge (24) |
| 34 | semicircular outer edge (14) |
| 36 | lower flange edge (20, 22) |
| 38 | upper flange edge (22) |
| 40 | roller block on wheels |
| 42 | 220 liter - frame |
| 44 | 300 liter - frame |
| 46 | outlet pipe with valve (14) |
| 48 | 3 inch-bunghole (24) |
| 50 | 2 inch-bunghole (24) |
| 52 | agitator/mixing tool (24) |
| 54 | arrow for flange edge clamping |
| 56 | filling/discharging pumping pipe |
| 58 | welding area (20, 22) |
| 60 | fastening means (12, 36) |
| 62 | circumferential edge (36) |
| A | large distance (20, 62) |
| a | small distance (20, 62) |

1. A mixing vessel (10) for mixing liquid or fluid filling goods, with a cylindrical vessel wall (12) and a disc-shaped lower vessel bottom (14) wherein at least four individual, detachably connected vessel components, namely a cylindrical vessel wall (12), a disc-shaped lower vessel bottom (14), a liner bag (16) made of thin-walled synthetic foil which is inserted into said vessel wall (12), and a clamping ring (18) which connects the disc-shaped lower vessel bottom (14) with the vessel wall (12), whereby said inserted liner bag (16) comprises a cylindrical liner wall (20) with a disc-shaped liner bottom (22) permanently welded onto it, and said disc-shaped liner bottom (22) having a flange edge (36) protruding beyond the cylindrical liner wall (20), with said flange edge (36) in the inserted state being arranged circumferentially between the disc-shaped lower vessel bottom (14) and the lower edge of the vessel wall (12) and being clamped firmly and non-rotatably by the installed lower clamping ring (18).

2. The mixing vessel (10) according to claim 1, wherein a disc-shaped upper vessel lid (24) and a second, upper clamping ring (26) connecting the upper vessel lid (24) with an upper rolled edge (30) of the vessel wall (12) are mounted on the four individual, detachably connected vessel components (12, 14, 16, 18).

3. The mixing vessel (10) according to claim 1, wherein the liner bag (16) comprises at the upper edge of its cylindrical liner wall (20) a part of the cylindrical liner wall which protrudes beyond the upper rolled edge (30) of the cylindrical vessel wall (12), and which in the inserted state is folded outward over the upper rolled edge (30) of the vessel wall (12) and clamped firmly and non-rotatably by the upper clamping ring (26).

4. The mixing vessel (10) according to claim 1, wherein the liner bag (16) comprises at the upper edge of its cylindrical liner wall (20) a flange edge (38) protruding outward, which in the inserted state is arranged between the upper rolled edge (30) of the vessel wall (12) and the disc-shaped upper vessel lid (28) and clamped firmly and non-rotatably by the upper clamping ring (26).

5. The mixing vessel (10) according to claim 1, wherein on the underside of the upper vessel lid (24) a separate disc-shaped liner foil with a diameter at least as wide as the diameter of the upper vessel lid (24) is arranged, with the outer edge of the disc-shaped liner foil being arranged between the outer edge of the upper vessel lid (24) and the upper rolled edge (30) of the cylindrical vessel wall (12) and being clamped firmly and non-rotatably by the upper clamping ring (26).

6. The mixing vessel (10) according to claim 1, wherein the upper vessel lid (24) comprises at least one bunghole (48, 50) closable with a bung into which an agitator/mixing tool (52) can be inserted.

7. The mixing vessel (10) according to claim 1, wherein the individual vessel components, namely cylindrical vessel wall (12), disc-shaped lower vessel bottom (14), lower clamping ring (18), disc-shaped upper vessel lid (24) and upper clamping ring (26) are made of sheet steel and any of these are formed as standardized components as used in the production of common steel drums.

8. The mixing vessel (10) according to claim 1, wherein the cylindrical vessel wall (12) is made of plastic or layered kraft paper (=fiber drum) and the disc-shaped upper vessel lid (24) and/or the disc-shaped lower vessel bottom (14) is made of plastic or plywood.

9. A liner bag (16) of thin-walled plastic foil with a cylindrical liner wall (20) and a liner bottom (22) permanently welded on, said liner bag to be inserted into a mixing vessel (10) according to claim 1, wherein the disc-shaped liner bottom (22) comprises a flange edge (36) protruding beyond the diameter of the cylindrical liner wall (22) and said flange edge (36) having a width of at least 10 mm.

10. The liner bag according to claim 9, wherein the cylindrical liner wall (20) at its upper edge also comprises a flange edge (38) protruding outward having a width of at least 10 mm.

11. The liner bag according to claim 9, wherein the outer circumferential edge of the liner bottom (22) that is welded onto the cylindrical liner wall (20) alternately shows a larger and a smaller distance (A, a) to the cylindrical liner wall (20).

12. The liner bag according to claim 9, wherein the smaller distance (a) between the liner bottom (22) that is welded onto the cylindrical liner wall (20) and the cylindrical liner wall (20) is at least 20 mm to the circumferential edge.

13. The liner bag according to claim 9, wherein the larger distance (A) between the liner bottom (22) that is welded onto the cylindrical liner wall (20) and the cylindrical liner wall (20) is at most 200 mm to the circumferential edge.

14. The liner bag according to claim 9, wherein the liner bottom (22) that is welded onto the cylindrical liner wall (20) has a square shape.
